(19) United States
(12) Patent Application Publication
(10) Pub. No.: US 2012/0288729 A1
(43) Pub. Date: Nov. 15, 2012

(54) REINFORCING SYSTEM AND METHOD

(76) Inventors: Simone De-Gale, Surrey (GB); Thomas Richard Shelley, Chatham (GB)

(21) Appl. No.: 13/497,507

(22) PCT Filed: Sep. 20, 2010
(86) PCT No.: PCT/EP2010/063762

§ 371 Date: Jun. 27, 2012

(30) Foreign Application Priority Data
Sep. 21, 2009 (GB) 0916508.5

(51) Int. Cl. B32B 1/04

(52) U.S. Cl. 428/603; 428/174; 428/57; 428/76; 428/64.1

(57) ABSTRACT

The present invention is directed to the use of one or more pre-stressed curved members, to enhance the strength of any curved structure. It is envisaged that the use of pre-stressed curved members in a range of curved structures according to the present invention could be used to reinforce aircraft, vehicles, warships/submarines and the like. It is further envisaged that the present invention could also be applied to shaped sections of amour for the protection of buildings, vehicles or human personnel.

There are many instances where dome, curved or spherical structures have to resist external pressure or blast waves. Examples include built structures made of concrete or structures made of fibre reinforced composite to protect radar antennae on ships and aircraft. There is a particular need to protect lightly or un-armoured vehicles from explosive devices placed either in roadways or to one side.

In a first aspect the invention relates to a curved structure having one or more curved member wherein the curved member is in tension on one side of its curvature and in compression on the other side of its curvature.

In a second aspect the invention relates to a curved structure wherein the curved member is in tension on the outer surface of its curvature and is in compression on the inner surface of its curvature for reinforcing the curved structure against external pressure.

In another aspect the invention relates to a curved structure wherein the curved member is in tension on the inner surface of its curvature and is in compression on the outer surface of its curvature for reinforcing the curved structure against internal pressure.

In another aspect the invention relates to a curved structure wherein the curved structure is a pressure vessel.

In another aspect the invention relates to a curved structure wherein a plurality of curved members are arranged side by side.

In another aspect the invention relates to a curved structure wherein a plurality of curved members are arranged in a gridshell.

In another aspect the invention relates to a curved structure wherein the one or more curved member is formed from steel, reinforced concrete, wood, plywood, fibre reinforced polymer resin, fibre reinforced ceramic, or other composite material.

In another aspect the invention relates to a curved structure wherein the tension on one side of the curvature of the curved member and the compression on the other side of the curvature of the curved member is caused by the weight of the curved structure.

In another aspect the invention relates to a curved structure wherein the tension on one side of the curvature of the curved member and the compression on the other side of the curvature of the curved member is caused by surrounding the curved member in a pliable matrix material, pre-loading the curved member then converting the pliable matrix material to a rigid material which holds the curved member in place.

In another aspect the invention relates to a curved structure wherein the tension on one side of the curvature of the curved member and the compression on the other side of the curvature of the curved member is caused by, pre-loading the curved member then attaching the ends of the circular member to a ring which holds the curved member in place.

In another aspect the invention relates to a curved structure wherein the tension on one side of the curvature of the curved member and the compression on the other side of the curvature of the curved member is caused by, pre-loading two or more curved members then attaching the two or more curved members together to hold the two or more curved members in place.

In another aspect the invention relates to the use of the curved structure to resist one or more of: pressure waves; blast waves; external pressure; or internal pressure.

In another aspect the invention relates to a curved structure for use in forming:

a) part of a complete armour system that resists projectiles and/or fragments in addition to blast;

b) part of the body shell of a motor vehicle;

c) part or all of the fuselage of an aircraft;

d) part or all of the hull of a ship;

e) part or all of the hull of a submarine; or

f) part or all of the construction of a building.

### DESCRIPTION OF THE DRAWINGS

FIG. 1: illustrates the underlying principle of Blast Absorption Systems according to the present invention

FIG. 2: shows a Plan of a blast absorption system in an armed forces land vehicle

FIG. 3: shows a Front elevation of a blast absorption system in an armed forces land vehicle

FIG. 4: shows a side elevation of a blast absorption system in an armed forces land vehicle

FIG. 5: shows a blast and pressure resistant radome protection system on the front of an aircraft

FIG. 6: shows a blast absorption system to protect radar antenna on top of the hull of a warship/submarine

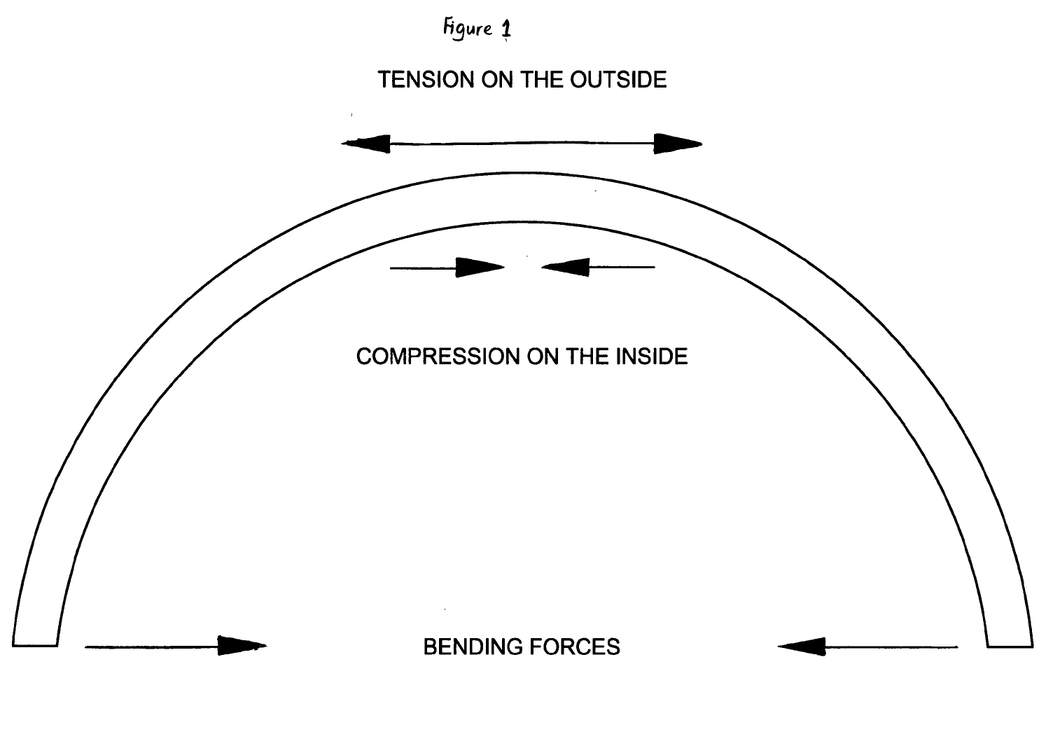

With reference to FIG. 1 the ratio of strength and blast resistance to weight of a curved structure can be enhanced by incorporating a plurality of curved members 1 into the curved structure. One or more of the curved members may be pre-stressed, so that it is in tension on the outer side 2 of its curvature and in compression on the inner surface 3 of its curvature.

When an external pressure such as that generated by a blast wave contacts the outer surface of the curved member, the pressure wave has first to overcome the tension on the outer surface 2 of the curved member. It then has to overcome the compression on the inner surface 3 of the curved member. Only once these forces have been reversed can the external pressure wave exert failure stresses on the curved structure.

Conversely, if the one or more curved member is pre-stressed so that it is in tension on the inner surface 3 and in compression on the outer surface 2, the curved member may be used to increase the pressure holding capacity of a pressure vessel.

In either case the curved member is constrained by pre-load forces so that it is bent round further than it would be in a relaxed state. This results, in either a tensile load on its outer surface 2 and a compressive load on its inner surface 3 or vice versa.

An incoming blast wave then has to convert the tensile load to a compressive load and the compressive load to a tensile load in order to begin to collapse the curved member and the curved structure which it supports.

Conversely the forces exerted on the curved member generated by internal pressure within a pressure vessel can be higher than in conventional pressure vessels without risking damage.

Sources of external pressure waves are by way of example only: gusts of wind; pressure resulting from the passage of an aeroplane through the atmosphere; pressure acting on the hull of a submarine; or the shock wave resulting from an explosion.

Optionally the one or more curved members can be arranged side by side, or in a pattern commonly known as a gridshell, similar to that found in a basket of open weave, where adjacent curved members pass over and or under each other so as to provide mutual reinforcement.

Optionally two or more curved members are joined together at the points where the curved members cross to further strengthen the curved structure.

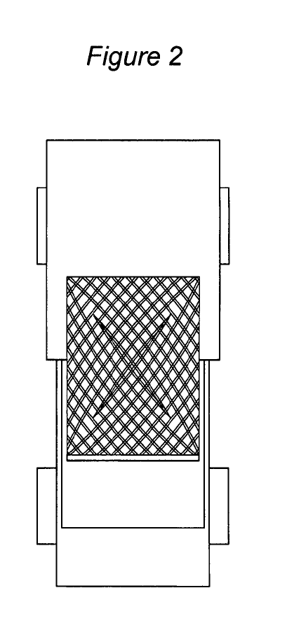

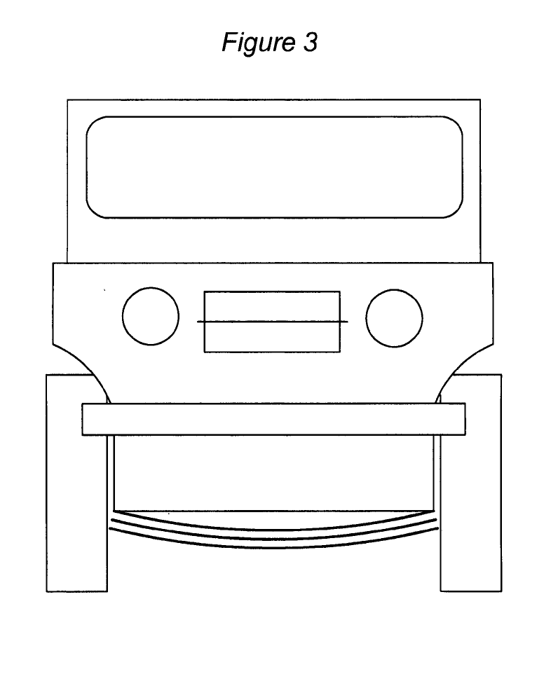

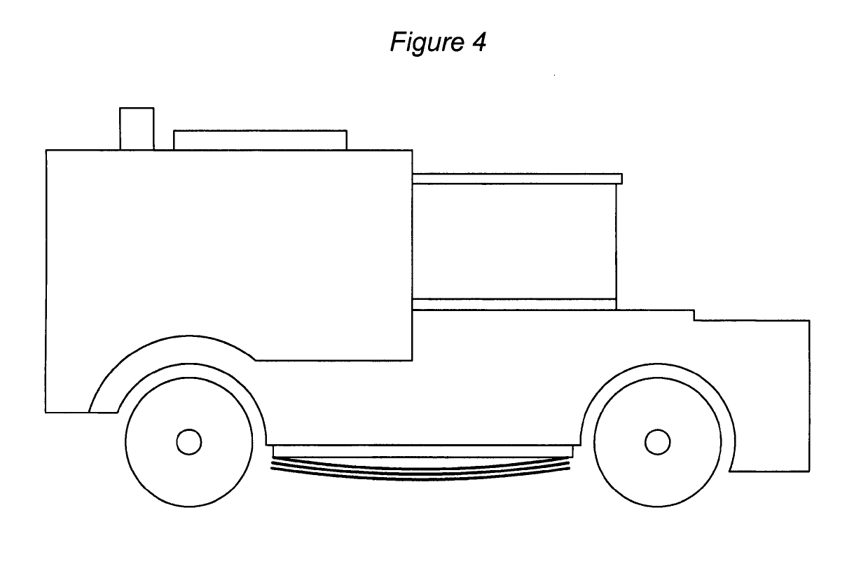

The use of unpre-stressed gridshells in the construction of buildings is known. As shown in FIGS. 2, 3 and 4 the present invention recognises that gridshells 4 of unpre-stressed, or pre-stressed jointed beams may have utility in the protection of vehicles based on existing technology.

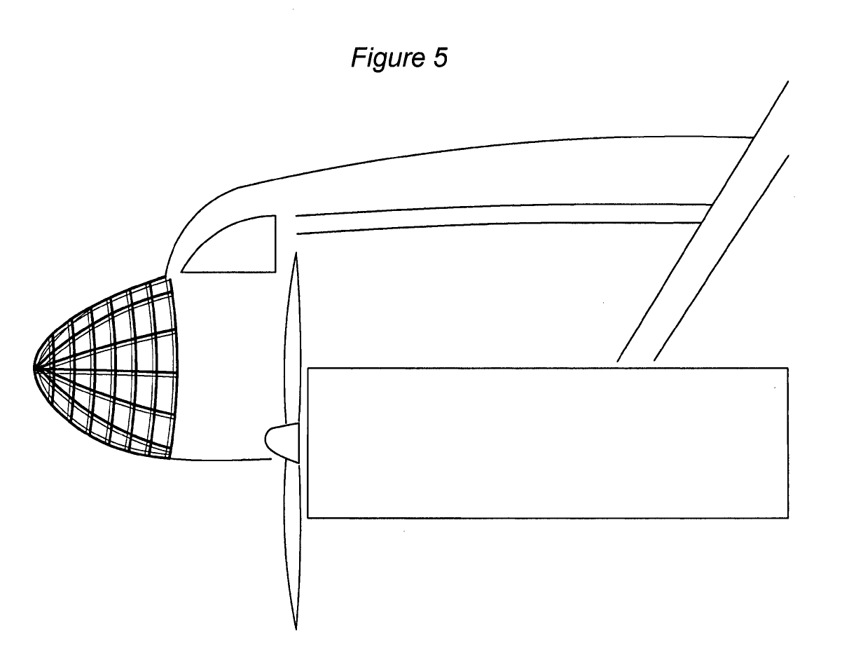

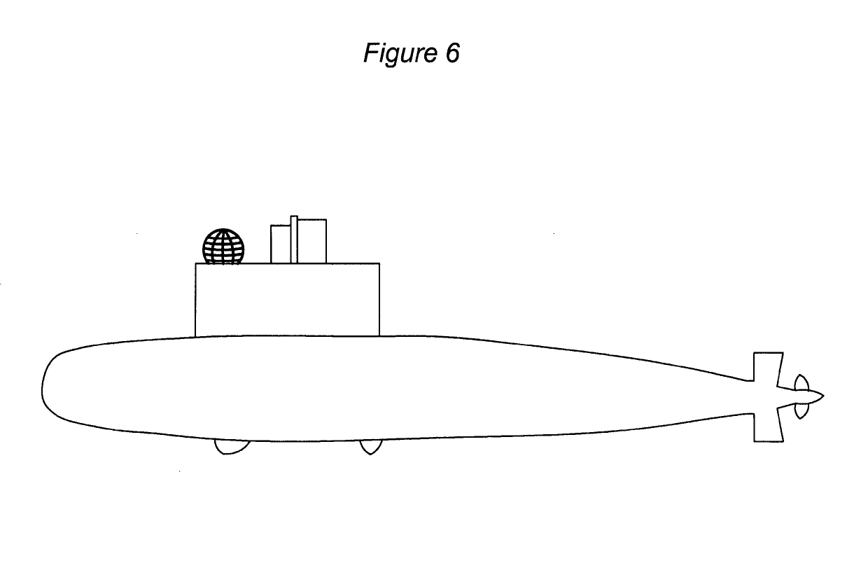

The present invention is directed to the use of one or more pre-stressed curved member, to enhance the strength of any curved structure. It is envisaged that the use of pre-stressed curved members in curved structures according to the present invention could be used to reinforce a range of items as shown in FIGS. 5 and 6 including by way of example only aircraft, vehicles, warships/submarines and the like.

It is further envisaged that the present invention could also be applied to shaped sections of armour for the protection of buildings, vehicles or human personnel. For the protection of human personnel, the armour could be made either as large, dome shaped elements, or smaller elements linked together. The technology could also be applied to the construction of radomes as shown in FIG. 6 for use on ships and aircraft and it could additionally be applied to the improved construction of pressure vessels and liquid holding tanks.

The curved reinforcing members can be made of a variety of materials including by way of example only steel, steel reinforced concrete, glass fibre reinforced polymer resin, carbon fibre reinforced resin, fibre reinforced ceramics, other composite materials, wood and plywood.

Pre-stressing the one or more curved member requires bending the curved member prior to the stress being locked in by the rest of the construction. Pre-stressing may be achieved by forming a matrix material around the curved member that would be allowed to set while the pre-stressed curved member is held in place. Alternatively pre-stressing could involve the pre-stressed curved member being attached to a ring at the base of the structure. Alternatively pre-stressing could involve the pre-stressed beams being attached to each other either using mechanical fasteners, welding, adhesives or the like. Alternatively in the case of a large construction, sufficient bending stress could be provided by the weight of the construction.

1. A curved structure having one or more curved member wherein the curved member is in tension on one side of its curvature and in compression on the other side of its curvature.

2. A curved structure as claimed in claim 1 wherein the curved member is in tension on the outer surface of its curvature and is in compression on the inner surface of its curvature for reinforcing the curved structure against external pressure.

3. A curved structure as claimed in claim 1 wherein the curved member is in tension on the inner surface of its curvature and is in compression on the outer surface of its curvature for reinforcing the curved structure against internal pressure.

4. A curved structure as claimed in claim 3 wherein the curved structure is a pressure vessel.

5. A curved structure as claimed in any preceding claim wherein a plurality of curved members are arranged side by side.

6. A curved structure as claimed in any preceding claim wherein a plurality of curved members are arranged in a gridshell.

7. A curved structure as claimed in any preceding claim wherein the one or more curved member is formed from steel, reinforced concrete, wood, plywood, fibre reinforced polymer resin, fibre reinforced ceramic, or other composite material.

8. A curved structure as claimed in any preceding claim wherein the tension on one side of the curvature of the curved member and the compression on the other side of the curvature of the curved member is caused by the weight of the curved structure.

9. A curved structure as claimed in any preceding claim wherein the tension on one side of the curvature of the curved member and the compression on the other side of the curvature of the curved member is caused by surrounding the curved member in a pliable matrix material, pre-loading the curved member then converting the pliable matrix material to a rigid material which holds the curved member in place.

10. A curved structure as claimed in any preceding claim wherein the tension on one side of the curvature of the curved member and the compression on the other side of the curvature of the curved member is caused by, pre-loading the curved member then attaching the ends of the circular member to a ring which holds the curved member in place.

11. A curved structure as claimed in any preceding claim wherein the tension on one side of the curvature of the curved member and the compression on the other side of the curvature of the curved member is caused by, pre-loading two or more curved members then attaching the two or more curved members together to hold the two or more curved members in place.

12. The use of a curved structure as claimed in any preceding claim to resist one or more of:
pressure waves; blast waves; external pressure; or internal pressure.

13. A curved structure as claimed in any preceding claim for use in forming:
a) part of a complete armour system that resists projectiles and/or fragments in addition to blast;
b) part of the body shell of a motor vehicle;
c) part or all of the fuselage of an aircraft;
d) part or all of the hull of a ship;
e) part or all of the hull of a submarine; or
f) part or all of the construction of a building.
